(19) United States
(12) Patent Application Publication
(10) Pub. No.: US 2005/0079339 A1
(43) Pub. Date: Apr. 14, 2005

(54) Decorative structures, decorative panels and method of making same

(76) Inventor: Guy Riddle, Santa Monica, CA (US)

Correspondence Address: Daniel J. Meaney, Jr., P.O. Box 22307, Santa Barbara, CA, 93121, US

(21) Appl. No.: 10/684,287

(22) Filed: Oct. 8, 2003

(51) Int. Cl. B32B 3/00

(52) U.S. Cl. 428/313.7

(57) ABSTRACT

A decorative structure for use as a decorative panel is shown. The decorative structure includes a substrate formed of fly ash in the form of ceramic balloons having a size of about 200 micron thinly coated with an amine cured epoxy resin in a ratio that is configured to optimize strength and coefficient of thermal expansion. A thin insulating coating is applied to a surface of the substrate and wherein said thin insulating coating has an outer surface that is spaced from said surface of the substrate. A thin coating of a finishing material applied to said outer surface of the thin insulating coating forming an exterior outer surface having a fabricated ornamental appearance. A method of forming a decorative structure is also shown.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates to a decorative structure which may be used as an attachable decorative panel which has an exterior viewing surface having a fabricated ornamental appearance and usable for a wall surface, construction material, building material, furniture material and for decorative applications wherein appearance is defined by the viewing surface ornamental appearance and more particularly to a decorative panel comprising a substrate formed of fly ash in the form of ceramic micro balloons having a size in the range of about 50 microns to about 500 microns thinly coated with a bonding agent, such as for example an amine cured epoxy resin, in a ratio that is configured to optimize strength and coefficient of thermal expansion and a coating layer of a finishing material applied to an outer surface of the substrate wherein the substrate is in the form of an open cell structure defined by the ceramic micro balloons by capillary action forming an exterior outer surface having a fabricated ornamental appearance which is a protective, outer layer providing protection from certain environmental conditions such as, for example, water, moisture, dust anti-fungal, anti-mildew and the like.

In the preferred embodiment, the decorative panel can be used as a decorative shell structure for enclosing objects such as, for example, pillars, beams and as a chafing dish serving station.

2. Description of the Prior Art

Decorative structures fabricated for application as a finished surface for large and small surfaces are known in the art. One example of a fabricated decorative surface is ARONITE brand Liquid Sandstone and Limestone which is a liquid stone surface for forming a decorative sandstone or limestone surface on a floor, driveway or the like.

Decorative panels having a substrate and a decorative outer surface for use a decorative structure for wall surfaces, pillars, gates, fences and the like are known in the art. One example of a waterproof lightweight grain-tone decorative panel is disclosed in U.S. Pat. No. 5,681,639. Specifically, the decorative panel disclosed in U.S. Pat. No. 5,681,639 comprises a waterproof grain-tone paint layer formed on the surface of a lightweight board such as a plastic foaming board or the like. In the decorative structure, micro-hollow fine ceramic particles of waterproof pressure strength of 600 kgf/cm² or more and a crushed natural stone particle are bound with a synthetic resin.

U.S. Pat. No. 4,729,918 discloses a coating for polystyrene foam products wherein the coating has a first latex layer formed of a copolymer of butadiene with either styrene or vinylidne chloride, or both, mixed with a fine aggregate such as silica flour or fly ash and a top layer made of one or more strata of a thermal setting resin. The resin is a thermal setting mixture of ethylenically unsaturated monomers and/or one or more of a number of specified resins. The resin is mixed with an aggregate of particle size ranges from about 10 microns to larger as required and a color pigment is added as required. The latex and resin with aggregate is applied over a polystyrene article to form a protected composite structure. The aggregate used in the coating can be as large as practically required for decorative or wear purposes. The last layer of resin can be applied without aggregate to form a smooth surface. Various surface finishing techniques can be used to make the surface as smooth as reasonably required.

U.S. Pat. No. 4,021,401 discloses a building material and method for making the same. The building materials are made of aggregate, which is bonded with resin. The so formed building materials are waterproof, have high controlled compressive and tensile strengths and retain the natural appearance of the aggregate used therein.

The disclosure of all of the above prior art references and Patents referred to in this specification are hereby incorporated by reference as if set forth verbatim herein.

The prior art decorative panels having a decorative external outer layer or coating have certain deficiencies and problems. During use and with the passage of time, the decorative structure having a decorative external outer layer or coating separates from the substrate or under layer of material resulting in a degradation of the visual appearance presented by the external outer layer and that is undesirable. If the crush strength or flex strength is unacceptable, then the decorative structure may become damaged.

Further, if decorative panels having a substrate with a decorative layer or coating formed thereon is used in certain applications such as for walls, wall surfaces, pillars, furniture or the like, separation, lifting or distortion of the decorative external outer layer or coating from the substrate or underlay material may result in the surface having an unattractive and defective visual appearance being presented by the external outer layer which is undesirable.

Further, the coefficients of thermal expansion between the materials forming the base and coating are not matched and under variations in temperature a mismatch of the coefficients of thermal expansion result in physical deformations in that the one of the base and coating expand greater that the other which is undesireable.

None of the prior art anticipate, disclose, suggest or teach a decorative structure comprising a substrate formed of fly ash in the form of ceramic micro balloons having a size in the range of about 50 microns to about 500 microns thinly coated with a suitable bonding agent, e.g. an amine cured epoxy resin, in a ratio that is configured to optimize strength and coefficient of thermal expansion and a coating layer of a finishing material wherein the coating layer may comprise at least one of a coating material, coating treatment material and a thin compliant coating finishing layer applied to an outer surface of the substrate which is in the form of an open cell structure defined by the ceramic micro balloons by capillary action forming an exterior outer surface having a fabricated ornamental appearance.

Further, none of the prior art anticipates, discloses, suggests or teaches solutions to overcome or compensate for stress induced into a panel or structure due to differences in thermal expansion characteristics of materials used to fabricate the panels. Failure to compensate for the differences in thermal expansion characteristics of panels exposed to environmental conditions generally results in structural degradation of the panels over time.

Further, none of the prior art anticipate, disclose, suggest or teach a chafing dish serving station comprising a chafing dish supporting structure having a selected longitudinal length and a selected lateral width configured for forming a chafing dish receiving section for supporting at least one of a chafing dish and warming pan above a heating burner placed below the chafing dish receiving section and a decorative shell structure fabricated from a substrate and coating layer, as disclosed and taught herein, which is fire resistant so as enclose a heating burner and to have one of its spaced opposed outer walls positioned away from the chafing dish support structure to define a viewing surface having an exterior outer surface fabricated with a material depicting an ornamental appearance exposing the viewing surface to form a chafing dish serving station having an appearance defined by the viewing surface ornamental appearance.

### BRIEF SUMMARY OF THE INVENTION

The present invention seeks to overcome the problems of the prior art by providing a new, novel and unique decorative structure that can be used as a decorative panel for various applications.

In the preferred embodiment, a decorative structure comprises a substrate having a first surface and a second surface wherein the substrate is formed of fly ash in the form of ceramic micro balloons having a size in the range of about 50 microns to about 500 microns thinly coated with a bonding agent, e.g. amine cured epoxy resin, in a ratio that is configured to optimize strength and coefficient of thermal expansion and a coating layer of a finishing material wherein the coating layer may comprise at least one of a coating material, coating treatment material and a thin compliant coating finishing layer applied to an outer surface of the substrate in the form of an open cell structure defined by the ceramic micro balloons configured to adhere by capillary action forming an exterior outer surface having a fabricated ornamental appearance.

A chafing dish serving station for enclosing a chafing dish supporting structure is also disclosed herein. The chafing dish serving station enclose a chafing dish support structure having a chafing dish receiving section for supporting at least one of a chafing dish and warming pan above a heating burner placed below the chafing dish receiving section. The chafing dish serving station includes a decorative shell structure fabricated from as a decorative structure as disclosed and taught herein. The decorative shell structure is fabricated to be fire resistant so as enclose a heating burner and concurrently depicts a selected ornamental appearance.

Therefore, it is an advantage of the present invention to provide a decorative structure having a substrate or underlay in the form of a substrate comprising fly ash in the form of ceramic micro balloons having a size in the range of about 50 microns to about 500 microns thinly coated with an amine cured epoxy resin in a ratio that is configured to optimize strength and coefficient of thermal expansion.

Another advantage of the present invention is that the decorative structure can be formed on a substrate or underlay using the teachings of this invention which includes a coating layer of a finishing material wherein the coating layer may comprise at least one of a coating material, coating treatment material and a thin compliant coating finishing layer applied to an outer surface of the substrate in the form of an open cell structure defined by the ceramic micro balloons configured to adhere by capillary action forming an exterior outer surface having a fabricated ornamental appearance.

Another advantage of the present invention is that the decorative structure can be formed comprising a substrate or underlay having at least one outer surface in the form of an open cell structure defined by the ceramic micro balloons using the teachings of this invention and a coating layer of a finishing material applied to the at least one outer surface of the substrate in the form of an open cell structure defined by the ceramic micro balloons configured to adhere by capillary action forming an exterior outer surface having a fabricated ornamental appearance.

Another advantage of the present invention is that the decorative structure is that the substrate having at least one outer layer can be fabricated with a selected coefficient of thermal expansion and the coating layer can be applied to said at least one outer surface having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

Another advantage of the present invention is that the decorative structure is that the substrate having at least one outer layer can be fabricated with a selected coefficient of thermal expansion and the coating layer can be applied to said at least one outer surface comprising a coating material and a coating treatment material having a coefficient of thermal expansion substantially equal to that of the substrate.

Another advantage of the present invention is that the decorative structure is that the substrate having at least one outer layer can be fabricated with a selected coefficient of thermal expansion and the coating layer can be applied to said at least one outer surface comprising a thin coating material finish layer having an expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

Another advantage of the present invention is that the decorative structure is that the substrate having at least one outer layer can be fabricated with a selected coefficient of thermal expansion and the coating layer can be applied to the at least one outer surface having a coating material and coating treatment material having an average a coefficient of thermal expansion substantially equal to that of the substrate.

Another advantage of the present invention is that the decorative structure is that the substrate having at least one outer layer can be fabricated with a selected coefficient of thermal expansion and the coating layer can be applied to the at least one outer surface having a coating material and coating treatment material having an average a coefficient of thermal expansion substantially equal to that of the substrate and a thin coating material finishing layer having a expansion characteristic configured to substantially absorb any difference in the coefficient of thermal expansions between the coating layer and substrate to substantially eliminate any physical deformation or stress between the substrate and coating layer forming an exterior outer surface having a fabricated ornamental appearance.

Another advantage of the present invention is that the decorative structure can be fabricated into a decorative panel to define a viewing surface having an exterior outer surface fabricated with a material depicting an ornamental appearance.

Another advantage of the present invention is that the decorative structure can be configured into a decorative panel for a wide variety of applications in the furniture, building and construction fields by presenting a selected visual appearance defined by the viewing surface ornamental appearance.

Another advantage of the present invention is that a decorative panel can be fabricated having a selected density, crush strength, flex strength, coefficient of thermal expansion, thermal K and Glass Transition Temperature Tg.

Another advantage of the present invention is that the decorative surface can be fabricated in many forms including, without limitation, in the form of a selected finish such as marble, granite, slate, faux surface, faux finish, colored finish, painted finish or any variation thereof or the like to project a theme, e.g., a waterfall picture surface for a Hawaiian theme.

Another advantage of the present invention is that the decorative surface can be fabricated in many forms to include thereon, without limitation, graphic images, pictures, logos, trademarks, trade names, service marks, individual or firm names, monograms, slogans, letters and the like affixed to or applied to the exterior surface of the decorative panel forming a viewing surface to project an desire visual appearance.

### BRIEF DESCRIPTION OF THE DRAWING

The present invention will become more fully understood from the following detailed description of a preferred but non- limiting embodiment thereof, described in connection with the accompanying drawings, wherein:

FIG. 1 is a pictorial representation of a decorative structure formed of a substrate and a coating layer of finishing material using the teachings of the present invention;

FIG. 2 is a pictorial representation of the cross-section of a decorative structure illustrated in FIG. 1;

FIG. 3 is a top planar view of a thin coating material finishing layer applied to the outer surface of the substrate forming an exterior outer surface having a fabricated ornamental appearance;

FIG. 4 is a top, front and left side perspective view of a chafing dish serving station having, shown in phantom, a chafing dish support structure, a heating burner sub-assembly, a chafing dish and warming pan enclosed therein and chafing dish cover;

FIG. 5 is an exploded pictorial representation of a decorative shell rigid exterior wall members having spaced opposed outer walls having a vertical height substantially equal to the vertical height of a chafing dish support structure and configured as a sidewall to form a chafing dish serving station;

FIG. 6 is a pictorial representation partially in cross section of a decorative panel affixed to a building structure wall using an adhesive;

FIG. 7 is a pictorial representation partially in cross section of a decorative panel affixed to a building structure wall using fasteners;

FIG. 8A is a pictorial representation partially in cross section of a substrate top surface illustrating an open cell structure formed by the ceramic micro-balloons in a bonding agent;

FIG. 8B is a pictorial representation partially in cross section of a substrate top surface having an open cell structure formed by ceramic micro-balloons in a bonding agent having a coating layer applied thereto; and

FIG. 8C is an exploded pictorial representation partially in cross section of a substrate at least one outer surface having an open cell structure formed by the ceramic micro-balloons in a bonding agent and a coating layer applied thereto showing that the coating layer is absorbed into at least one outer surface of the substrate by capillary action.

### DETAILED DESCRIPTION OF THE INVENTION

### Background

Use of natural stone, such as marble, granite, sandstone, limestone and the like as materials for forming decorative structures results in finished wall, building structure or the like as is well known in the art. Such fabricated structures tend to be heavy, expensive and require the use of a skilled tradesperson to install the same. This had resulted in a trend in the fields of construction, building and related materials to form building materials in the form of separate decorative structure having a fabricated exterior surface wherein the decorative structures are preferably lightweight, fire proof and waterproof.

In certain applications it is desirable to have the exterior outer surface of the decorative structures function as a viewing surface and to have such a viewing surface have a selected fabricated ornamental appearance. Typically, such viewing surfaces are fabricated with synthetic materials or with a faux finish or faux surface to depict a desired ornamental appearance. A faux finish or faux surface is processed or manufactured surface that is formed of a false, artificial or simulated outer surface having an appearance of a natural material, e.g. stone, wood or the like.

Present day decorative structures generally comprise an underlay having a substrate that provides a structural support member having a desired rigidity and other physical characteristics required for the specific application. A specialized coating is applied to the substrate as an exterior outer surface having a fabricated finish to provide a selected ornamental appearance. With the passage of time, use and environmental conditions, the fabricated coating applied to a substrate tends to separate from the surface of the substrate.

In addition, the cost for fabricating the substrate used in a decorative application are subject to pricing pressures from the construction and building industry and other fields using such decorative structures, decorative panels formed as material components, e.g., interior walls and furniture. As such, these cost goals can be achieved using the novel and unique decorative structures and decorative panels fabricated using the teachings of this invention in order to achieve a desired fabricated ornamental appearance while meeting desired budgeted cost targets.

The decorative structure of the present invention utilizes a substrate that is formed of fly ash in the form of ceramic micro balloons, preferably having a size in the order of about 50 microns to about 500 microns. The fly ash is thinly coated with a suitable bonding agent, e.g. an amine cured epoxy resin, in a ratio that is configured to optimize strength and the coefficient of thermal expansion. The resulting decorative structure and decorative panels are lightweight, fire resistant, durable and machinable.

The so formed substrate is then coated with a coating layer of a finishing forming an exterior outer surface having a fabricated ornamental appearance. The exterior outer surface has a fabricated ornamental appearance which is a protective, outer layer providing protection from certain environmental conditions such as, for example, water, moisture, dust anti-fungal, anti-mildew and the like.

Fly ash material, as the preferred material for forming the substrate, results in several important features of the invention. Fly ash is a by-product of coal burning processes such as coal fueled electrical generating plants, is a by product that is difficult to dispose of thereby presenting environmental disposal problems and is typically disposed of in landfills and the like.

One known use of fly ash is for fabricating a substrate comprising a combination of fly ash and cement, but such a combination has unacceptable crush characteristics. Fly ash can be purchased in a screened, flocked and packaged units for a low as $0.50 per pound. Thus, the use of fly ash results in reducing the environmental disposal problems associated with fly ash, results in an economically advantageous price to reduce building material costs and when used in accordance with the teachings of the present invention can result in a highly desirable, useful, economical and decorative product.

The fly ash is in the form of ceramic micro-balloons and, in practicing this invention, the ceramic micro-balloons preferably have a size in the range from about 50 microns to about 500 microns. The preferred ceramic micro-balloons sizes are in the range from about is about 50 microns to about 300 microns with a size of about 200 microns being the most desirable.

The use of the term “substrate” as used herein is intended to cover a core panel, building structure panel, an underlay material or any similar structure made of micro-balloons bonded together with an amine cured resin, epoxy resin, an appropriate thermal set polymer or other suitable resin and used as a base element configured to having a coating layer formed, applied or coated thereon.

The substrate is formed of mixture of a combination of fly ash, in the form of ceramic micro balloons coated with amine cured resin, epoxy resin or other appropriate thermal setting materials or resins, such as for example, thermal setting epoxies, phenolics, polyurethane, polyamides, polyester, polybutadiene and the like, collectively referred to herein after as “bonding agent”. The mixture is packed or pressed into a mold and is cured under pressure to form a substrate, e.g. a panel core. The pressure is in the range of about 5 PSI to about 20 PSI. The curing time is a function of a ratio of bonding agent, e.g. resin, to fly ash ceramic micro balloons. The curing time can be as low as 30 minutes or less or could be as long as 24 hours or more. The bonding agent, e.g. resin, content can be in the order of about 10 percent by weight to about 30 percent by weight but the preferred range of bonding agent content is about 10 percent by weight to about 20 percent by weight. The so formed substrate has a high crush content, in the order of greater than 1500 psi, as opposed to the prior art panels formed of fly ash and cement which have very low crush content, in the order of 1000 psi.

Decorative panels fabricated using the teachings of the invention have technical and physical characteristics which meet or comply with the requirements of various standards such as for example, UL re flammability requirements, building codes re structural integrity requirements and the like.

### Decorative Structure and Decorative Panel and Method of Making Same

In the description of the invention set forth herein, common elements in the various views of the figures are identified by the same element number.

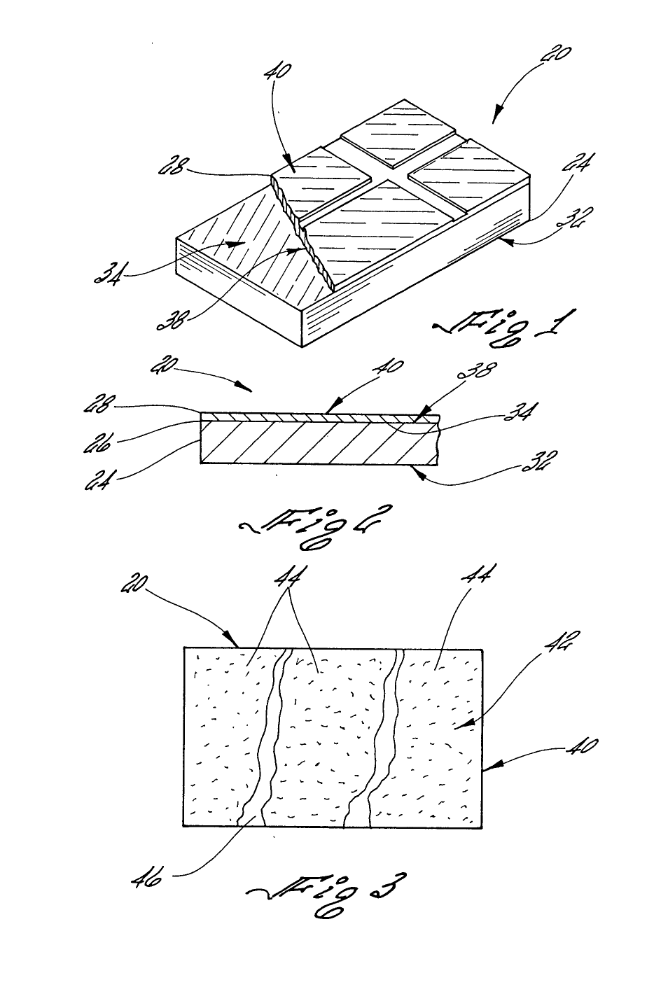

FIGS. 1 and 2 illustrates a decorative structure 20 that is fabricated as a decorative panel. The decorative structure 20 comprises a substrate 24 and a coating layer 28.

The substrate 24 is formed of fly ash in the form of ceramic micro balloons having a size of about 50 microns to about 500 microns thinly coated with a bonding agent, preferably, an amine cured epoxy resin, in a ratio that is configured to optimize strength and coefficient of thermal expansion. The preferred sizes of the ceramic micro balloon is about 50 microns to about 300 microns with about a 200-micron sized being the most desirable size.

In the preferred embodiment, the substrate comprises about 80% by weight to about 90% by weight of fly ash ceramic micro balloons and about 10% by weight to about 20% by weight of amine cured epoxy resin. In the preferred embodiment, the amine cured epoxy resin may comprise an amine cured Bisphenol-A based epoxy resin. It is envisioned that the bonding agent may comprise any curable epoxy, amine epoxy or other suitable epoxy, resin or bonding material known to a person skilled in the art which results in a decorative structure having the desired physical characteristics including an optimized strength and coefficient of thermal expansion can be used in practicing this invention.

In FIGS. 1, 2 and 3, the substrate 24 has a first surface 32 and a second surface 34. The coating layer 28 has a pair of opposed surfaces 38 and 40. The coating layer 28 having a pair of opposed surfaces 38 and 40 is applied to substrate 24 wherein one of the pair of opposed surfaces, for example surface 38, is applied to one of the first surface 32 and 34 and second surface of the substrate, for example second surface 34.

The coating layer 28 layer may comprise a coating material, a coating treatment material, or a thin coating material finishing layer or any combination thereof to form a finishing surface having on surface 40 an exterior outer surface 42 having a fabricated ornamental appearance.

Examples of the coating layer configured as a finishing material include, without limitation, simulated stone, simulated panel coating, a faux finish, a faux finish having a milled aggregate in a water based acrylic emulsion, a faux finish fabricate from an Aronite brand coating material or any other materials and techniques for forming a viewing surface having a selected ornamental appearance.

The preferred properties and technical characteristics of the decorative structure 20 are as follows:

| Property | Technical Characteristics |
|---|---|
| Density | About 27 lbs/cu ft to about |
| | 30 lbs/cu ft |
| | (0.43 g/cc-0.48 g/cc) |
| Crush strength | >1500 psi |
| Flex strength | >250 psi |
| CTE | About 6 ppm/inch/degree to about |
| | 7 ppm/inch/degree F. |
| Thermal K | 0.1 Watt/meter/K |
| Glass Transition Temperature | >200 F. |
| (Tg) | |

Tg represents the Glass Transition Temperature that is the temperature at which a material softens. The decorative panel comprising the substrate maintains essentially a rigid solid physical property at a lower temperature, approximately 150 degrees Fahrenheit or less, and as the temperature approaches the Glass Transition Temperature, the decorative panel looses a majority of its physical properties and enters into a plastic state. An analogy is glass. At a lower temperature, glass rigid and solid. When the Glass Transition Temperature, Tg, is reached, the glass transforms from a rigid state into a plastic state. Thus, the Glass Transition Temperature, Tg, of the decorative panel is preferably at least 50 degrees Fahrenheit greater than the highest possible temperature to which the substrate or decorative structure is to be exposed. Thus a Tg of greater than 200 degrees F. enables use of a decorative panel up to temperature to about 150 degree F. without the decorative panel loosing a majority of its physical properties and entering into a plastic state.

The decorative structure can have the substrate configured to have at least one of the following characteristics: a density in the range of about 27 lbs/cu ft to about 30 lbs/cu ft; a crush strength of greater than 1500 psi; flex strength of greater than 250 psi; a coefficient of thermal expansion in the range of about 6 ppm/inch/degreeF. to about 7 ppm/inch/degreeF.; Thermal K of greater than 0.1 Watt/meter/K and a Glass Transition Temperature, Tg of greater than 200 degree F.

In practicing this invention, the coefficient of thermal expansion of the substrate is selected to be substantially in the range of the coefficient of thermal expansion of the coating layer to be affixed thereto so as to prevent the buildup of other stresses that would develop if the coefficient of thermal expansions of the substrate and coating layer, respectively, were significantly different. In the preferred embodiment of the present invention, the coefficient of thermal expansion of the substrate is selected to be in the range of about 6 PPM/inch/per degree F. to about 7 PPM/inch/per degree F. which matches the coefficient of thermal expansion of both low carbon steel and stainless steel. Also, it is preferable to substantially match the coefficient of thermal expansion of the decorative panel and the support structure to which the decorative structure or decorative panel is affixed.

The greater the mismatch of the coefficient of thermal expansion between a decorative panel formed of a substrate having a coating and the support structure of a structure, e.g. building, supporting the decorative panel, the greater the likelihood that the decorative panel would buckle on the support structure. Typically, a building support structure could be plate steel or a steel structure and the decorative panels could be utilized as a curtain wall. A curtain wall is essentially an outside veneer attached to a steel structure or other type support structure.

By using aggregate in the coating layer, the coating layer would essentially have a coefficient of thermal expansion substantially equal to that of the substrate causing the average coefficient of thermal expansion of the decorative panel to be equal to that of steel which is highly desirable.

For example, the coating layer may comprise a combination of a coating material and aggregate. The higher the amount of the aggregate in the coating layer, the lower the coefficient of thermal expansion of the coating material, for example, a coating material could be selected that has a coefficient of thermal expansion of about 40 and the aggregate material would be selected that had a coefficient of thermal expansion of about 3 which would make the average coefficient of thermal expansion of the coating layer somewhere between about 10 PPM to about 20 PPM. On the other hand, certain materials, e.g., foam, could not be used as a substrate or coating layer or coating material because the foam has such a high coefficient of thermal expansion that the panel would buckle when exposed to environmental conditions.

In the alternative, the coating layer may be a thin coating material finishing layer in the form of a compliant coating material having a expansion characteristic such that the coating layer can stretch or expand to absorb the relative difference in the coefficient of thermal expansion to substantially offset buckling or other physical deformation that could occur between the coating layer and substrate thereby providing a coating layer having a substantially matching coefficient of thermal expansion characteristics to that of the substrate.

Of course, the coating layer could be configured of both a coating material and a thin coating material finishing layer or a combination of two or more of a coating material, coating treatment material and a thin coating material compliant layer to take advantage of the a combination coefficient of thermal expansion being substantially equal to that of the substrate and thin coating material complaint layer having an expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

Thus, in the preferred embodiment of the present invention, the decorative structure may comprise a substrate formed of fly ash in the form of micro ceramic balloons having a size of in the range of about 50 microns to about 500 microns thinly coated with a bonding agent, preferably a resin, in a ratio that is configured to optimize strength and coefficient of thermal expansion and form an open cell structure of ceramic micro balloons on at least one outer surface of the substrate. A coating layer is applied to the at least one outer surface of the substrate which forms a aggressive bonding therebetween by wicking or by capillary action and which has at least one of a coefficient of thermal expansion substantially equal to that of the substrate and an expansion characteristic configured to substantially absorb any difference in the coefficient of thermal expansions between the coating layer and substrate to eliminate any physical deformation between the substrate and coating layer forming an exterior outer surface having a fabricated ornamental surface. The coating layer may comprise a coating material and a coating treatment material, e.g. aggregate, to obtain a desired or selected coefficient of thermal expansion or comprise a thin coating layer having an expansion characteristic configured to substantially absorb any difference in the coefficient of thermal expansions between the coating layer and substrate, or both.

Thus, by substantially matching the coefficients of thermal expansion as set forth herein, any substantial physical deformation between the substrate and coating layer is substantially eliminated forming a substantially physical deformation free exterior outer surface having a fabricated ornamental appearance.

The decorative structure 20 including the substrate 24 may be fabricated into or formed into a selected shape.

The top planar view of an outer surface of the coating layer, which is in the form of a finished ornamental surface of the decorative structure 20, is illustrated in FIG. 3 and is shown by arrow 42. The coating layer 28 having the finished ornamental surface 42 is applied to the surface 34 of the substrate forming on the substrate an exterior outer surface having a fabricated ornamental appearance.

In FIG. 3, one of the opposed surfaces 40 of the coating layer 28 forming an exterior outer surface 42 having a fabricated ornamental appearance is depicted, for illustrative purposes, as pictorially as having three regions or areas 44 separated by grooves or depressed valleys 46. The three regions or areas 44 are depicted as having a milled aggregate with the areas 44 separated by continuous, variable width grooves to form the desired ornamental appearance.

In its broadest aspect, the teachings of this invention related to a fabricated underlay for use as a component in a decorative structure. The fabricated underlay comprises a substrate 24 formed of fly ash in the form of ceramic micro preferably having a selected size of about 200 microns thinly coated with an amine cured epoxy resin in a predetermined ratio that is configured to optimize strength and coefficient of thermal expansion.

The underlay has applied to one surface thereof a coating layer 28 having an exterior outer surface 42 having a fabricated ornamental appearance forming an exterior outer surface having a fabricated ornamental appearance.

The underlay substrate may comprises about 80% by weight to about 90% by weight of fly ash ceramic micro balloons and about 10% by weight to about 20% by weight of amine cured epoxy resin and can be fabricated into a any desired shaped using a mold.

A method of forming a decorative structure is also taught by this invention. The method comprising the steps of: (a) fabricating a substrate of fly ash in the form of ceramic micro balloons having a size in the range of about 50 microns to about 500 microns thinly coated with a bonding agent, e.g. an amine cured epoxy resin, in a ratio that is configured to optimize strength and coefficient of thermal expansion; and applying to the outer surface of the substrate configured to adhere by capillary action a coating layer having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

The method in the step of fabricating a substrate may include use of a substrate comprising about 80% by weight to about 90% by weight of fly ash ceramic micro balloons and about 10% by weight to about 20% by weight of amine cured epoxy resin.

The method in the step of fabricating a substrate may include making the substrate fire resistant.

The method in the step of applying to the outer surface may include using a material having a milled aggregate in a water based acrylic emulsion.

The method in the step of applying to the outer surface may include using a material that is a simulated panel coating.

One application for using the teachings of the present invention of the decorative structure is to use the same as decorative panels or decorative shells for enclosing an object.

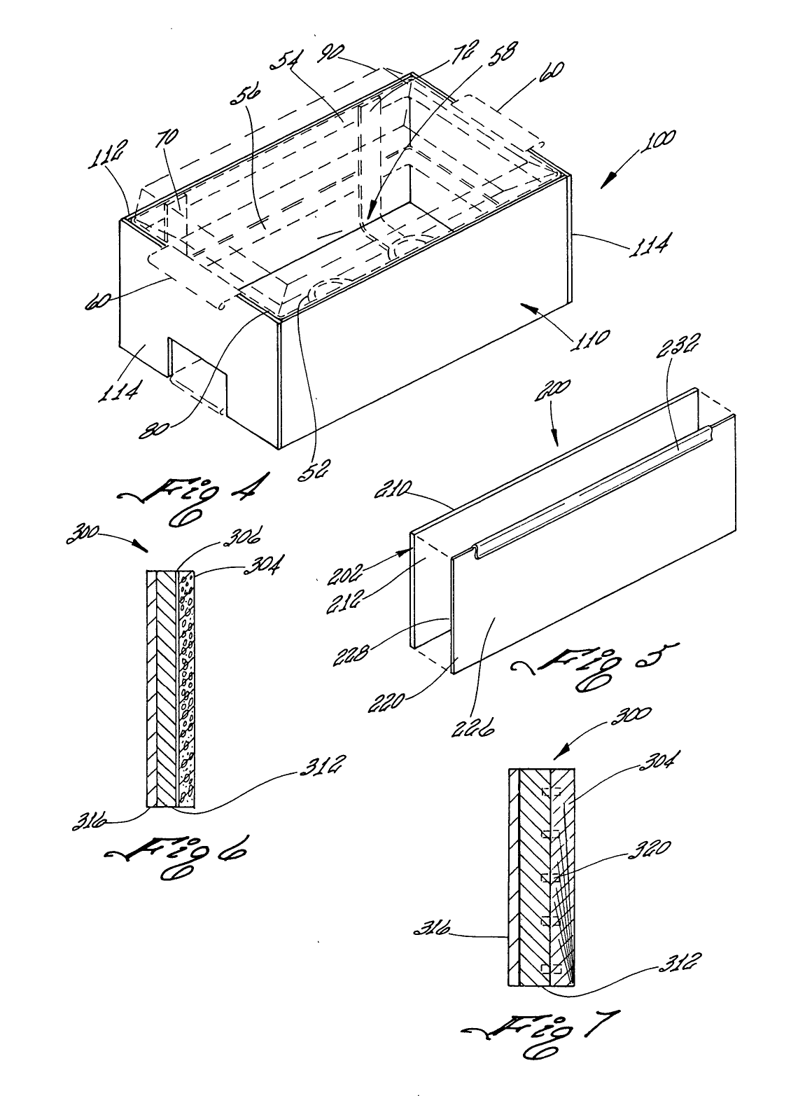

In FIG. 4, a top, front and left side perspective view of a chafing dish serving station 100 having, shown in phantom, a chafing dish support structure shown by arrow 50, a heating burner sub-assembly 52, a chafing dish and warming pan 80 enclosed therein and chafing dish cover 90 is shown.

In this embodiment, the chafing dish serving station 100 comprises a chafing dish supporting structure 50 that may be in the form of any known chafing dish support structure. The chafing dish support structure 50 enclosed by the chafing dish serving station 100 has a selected longitudinal dimension, a selected lateral dimension and selected vertical height and is configured in a selected shape for forming a chafing dish receiving section 58 for supporting a chafing dish/warming pan 80 above a heating burner 52 placed below the chafing dish/warming pan 80.

Chafing dish support structures may be fabricated in numerous forms and shapes. Examples include a rectangular chafing dish disclosed in U.S. Pat. Nos. 4,899,722 and Des 468,580.

In this embodiment, the chafing dish support structure 50 comprises a pair of spaced, co-planar elongated sidewall defining members 54 and 56 having a selected longitudinal dimension and a selected lateral dimension. The shaped is generally rectangular shape. However, it is envisioned that the chafing dish support structure 50 can be fabricated into any desired shape including, without limitation, square shaped, oblong shaped, oval shaped, circular shaped, triangular shaped or any other geometrical shape.

Sidewall defining members 54 and 56 are configured for forming a chafing dish receiving section, designated generally as 58, for supporting at least one of a double-boiler heating pan or heating warming pan, collectively referred to hereinafter as a “warming pan”, and a serving dish or chafing dish above a heating burner shown by dashed lines 52 which is placed below the chafing dish receiving section 58. Each of said sidewall defining members 54 and 56 are fixedly rigidly attached to opposed end structural members that define lifting members 60 and 62 respectively. The shape of the chafing dish receiving section 58 would be dictated or determined by the selected shape of the chafing dish support structure. Likewise, the shape of a warming pan, serving dish or chafing dish would be dictated by or determined the selected shape of the chafing dish support structure.

A pair of spaced, elongated co-planar support members 70 and 72, defining horizontal and vertically extending support members, are operatively connected to each of the sidewall defining members 54 and 66 at predetermined locations for supporting the chafing dish receiving section 58 above a heating burner placed 52 below at least one of a chafing dish and warming pan positioned in the chafing dish receiving section 58.

A decorative shell structure, shown generally by arrow 110, has at least two pair of decorative shell rigid exterior wall members 112 and 114 having spaced opposed outer walls having a vertical height substantially equal to the selected vertical height of the chafing dish support and a selected lineal dimension so as to enclose the chafing dish structure and heating burner. The two pair of decorative shell rigid exterior wall members 112 and 114 have a total lineal length substantially equal to that of the lineal outer dimension of the chafing dish support structure.

FIG. 5 is an exploded pictorial representation of a decorative shell rigid exterior wall members 112 and 114 have spaced opposed outer walls having a vertical height substantially equal to the vertical height of a chafing dish support structure and configured as a sidewall to form a chafing dish serving station;

FIG. 5 illustrates a decorative shell rigid exterior wall member 200 which can be used as the decorative shell rigid exterior wall members 112 and 114 being removeably attached to the chafing dish support structure 50. The decorative shell rigid exterior wall members 112 and 114 are fabricated from a material that has appropriate physical characteristics including being fire resistant so as enclose a heating burner.

As illustrated in FIG. 5, the decorative shell structure rigid exterior wall members 112 and 114 have one of the spaced opposed outer wall positioned away from the chafing dish support structure 50 to define a viewing surface. The viewing surface has an exterior outer surface fabricated with a material depicting an ornamental appearance forming a chafing dish serving station having a visual appearance defined by the viewing surface ornamental appearance.

Referring back to FIG. 5, the exploded pictorial representation of decorative shell rigid exterior wall member 200 has a substrate 202 having spaced opposed outer walls 210 and 212 having a vertical height substantially equal to the vertical height of a chafing dish support structure and configured as a side wall to form a chafing dish serving station 100.

The substrate 202 is fabricated to have a first surface and a second surface defining the spaced opposed outer walls 210 and 212. The substrate is formed of a material that is configured to optimize strength to function as a rigid exterior wall member and having a selected coefficient of thermal expansion to maintain its strength when exposed to heat from a heating burner, e.g., heating subassembly 52. The substrate 202 has formed thereon a thin coating of a finishing material applied to one of the pair of opposed surfaces, e.g. opposed outer wall 210, in the form of a thin coating forming an exterior outer surface having a fabricated ornamental appearance.

A thin sheet member 220, having a first surface and a second surface 226 and 228, is used as a supporting member for mounting the substrate 200 to the chafing dish support structure. The first surface 226 is to be positioned contiguous the chafing dish support structure. The second surface 228 is to be rigidly attached to the opposed outer wall 212 with an appropriate adhesive, e.g. a heat resistant epoxy. The first surface 226 has an elongated slotted circumferential edge support 232 formed thereon which is configured to be removable attached to the circumferential edge of the upper member 54 of the chafing dish support structure for supporting the exterior outer surface 210 having a fabricated ornamental appearance thereon in a vertical orientation on the chafing dish support structure 50. With the decorative shell rigid exterior wall member removeably attached in a substantially vertical position on the chafing dish support structure, a chafing dish serving station 100 is formed having an appearance defined by the fabricated ornamental appearance.

The teachings of the present invention can be used to fabricate an interior wall, an exterior wall or as a decorative shell enclosing structure for an object.

The pictorial representation of FIG. 6, partially in cross section, illustrates a decorative panel 300 affixed to a building structure wall 304 using an adhesive 306. The decorative panel includes a substrate 312 and a coating layer 316 having an exterior outer surface having a fabricated ornamental appearance.

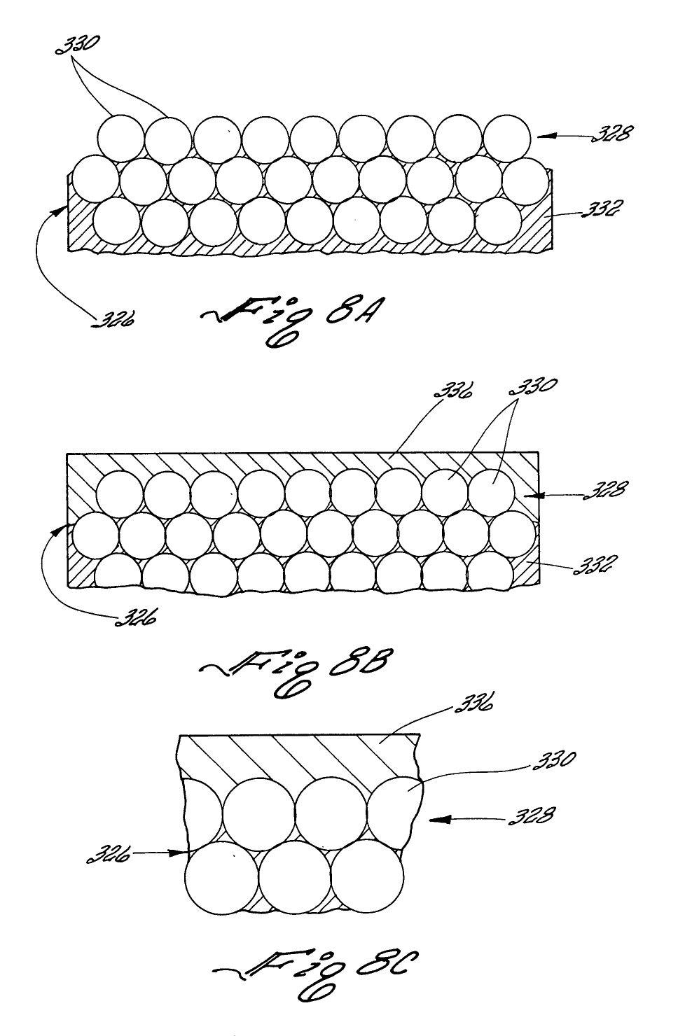

The pictorial representation of FIG. 7, partially in cross section, illustrates a decorative panel 300 affixed to a building structure wall 304 using fasteners shown by dashed lines 320. The decorative panel includes a substrate 312 and a coating layer 316 having an exterior outer surface having a fabricated ornamental appearance.

In FIG. 7, the thickness of the substrate 312 is thicker than that of substrate 312 shown in FIG. 6 in order to accommodate the length of the fasteners 320.

The fabricated decorative panel can be to a structure directly, such as building wall structure, as illustrated in FIGS. 6 and 7 above or can be affixed to a separate supporting member such as the thin sheet member 220, having a first surface and a second surface 226 and 228 which is used as a supporting member for mounting the substrate 200 to the chafing dish support structure illustrated in FIG. 5 above.

The decorative panel can be bonded or attached to the supporting structure by using suitable adhesives such as acrylics, silicones, acrylic modified silicones and polyurethanes or any other adhesive known to persons skilled in the art which meet the criteria set forth herein. In certain applications, the use of fasteners may result in stress being developed at the fastener/surface interface. As such, bonding a decorative panel may be preferable for mounting the same in lieu of fasteners.

In prior art structures using a solid material such as wood as the substrate, e.g. panel, and when fasteners are attached, the solid material is essentially pushed away by the fasteners such as occurs when screwing a screw into wood. In the case of the substrate having the ceramic micro balloons using the teachings of the present invention, a fastener when inserted into the substrate causes the ceramic micro balloons to fracture securing the fastener in place. Therefore, the ceramic micro balloon structure of the substrate enables the use of fasteners for attaching decorative panel to a building structure or support structure using fasteners as illustrated in FIG. 5 as discussed above.

The substrate fabricated using ceramic micro-balloon as described above results in a substrate, e.g. core material, that is essentially a porous open cell structure and, as such, does not need etching processing to form an open cell structure.

The top layer of the substrate is formed of a plurality of substantially spherical bubbles or spheres that are spherically tangentially bonded leaving the tops of the spheres exposed and open creating an open cell structure. The open cell structure permits outgassing without expansion and cracking. When a coating layer is applied to the open cell structure, the coating layer adheres to the open cell structure by capillary action or wicking of the coating into the open spaces of the open cell structure. The adhesion is sufficiently strong that any attempt to peal off the coating layer will result in a physical breaking up of the substrate top layer including the ceramic micro bubbles.

In FIG. 8A, the pictorial representation partially in cross section shows a substrate 326 having top surface shown by arrow 328 having an open cell structure formed by the ceramic micro-balloons 330 in a bonding agent, e.g. resin, 332.

In FIG. 8B, the pictorial representation partially in cross section of the substrate 326 having a top surface 328 having an open cell structure formed by the ceramic micro-balloons 330 in resin 332 having a coating layer 336 applied thereto.

In FIG. 8C, the exploded pictorial representation partially in cross section of the top surface 328 of substrate 326 having an open cell structure formed by the ceramic micro balloons 330 in resin 332 is illustrated as having a coating layer 336 applied thereto showing that the coating layer 336 is absorbed into the top surface 328 of substrate 326 and between the ceramic micro balloons by capillary action forming an aggressive adhesion or bond between the substrate 326 and coating layer 336.

The objects which could be enclosed using decorative panels fabricated using the teaching of this invention include for example and without limitation, interior pillars, exterior beams, plant, shrubbery and flower boxes, buffet serving stations and the like.

It is envisioned that the shape of an object or wall surface can be of any shape including a mobeous shape and a geometrical shape. Examples of popular shapes include a geometrical shape that may be a generally rectangular shape, a generally oval shape, a generally circular shape or a substantially planar or substantially curved or dimensioned wall surface.

It is also envisioned that graphic images, pictures, logos, trademarks, trade names, service marks, individual or firm names, monograms, slogans, letters and the like can be affixed to or applied to the exterior surface of the viewing surface to project an desire visual or theme appearance. Also, the viewing surface can be formed of a selected finish such as marble, granite, slate, faux finish, colored finish, painted finish or any variation thereof or the like to project a theme, e.g., a waterfall picture surface for a Hawaiian theme.

It will be appreciated that various alterations and modifications may be made to the decorative structure, decorative panels or underlay therefor to enhance the functional characteristics thereof. All such variations and modifications should be considered to fall within the scope of the invention as broadly hereinbefore described and as claimed hereafter.

All such uses, variations, modifications and the like are anticipated to be within the scope of this invention.

1. A decorative structure comprising
a substrate formed of fly ash in the form of ceramic balloons having a size of in the range of about 50 microns to about 500 microns thinly coated with in a bonding agent in a ratio that is configured to optimize strength and coefficient of thermal expansion and form an open cell structure of ceramic micro balloons on at least one outer surface of the substrate; and
a coating layer applied to said at least one outer surface having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

2. The decorative structure of claim 1 wherein the ceramic micro balloons size range from about 50 microns to about 300 microns

3. The decorative structure of claim 2 wherein the ceramic micro balloons are about 200 microns.

4. The decorative structure of claim 1 wherein the bonding agent is selected from a group consisting of an amine cured epoxy resin, epoxy resin and thermal setting polymer.

5. The decorative structure of claim 1 wherein the bonding agent is a resin.

6. The decorative structure of claim 5 wherein the resin is an amine cured epoxy resin.

7. The decorative structure of claim 6 wherein the amine cured epoxy resin may comprise an amine cured Bisphenol-A based epoxy resin.

8. The decorative structure of claim 1 wherein the coating layer is configured of a coating material having a coefficient of thermal expansion substantially equal to that of the substrate.

9. The decorative structure of claim 1 wherein the coating layer is configured of a coating material and a treatment material which in combination have a coefficient of thermal expansion substantially equal to that of the substrate.

10. The decorative structure of claim 1 wherein the coating layer is configured of a coating material and a treatment material which in combination have a coefficient of thermal expansion substantially equal to that of the substrate.

11. The decorative structure of claim 1 wherein the coating layer is configured of a at least one of a coating material and a treatment material which in combination have a coefficient of thermal expansion substantially equal to that of the substrate and thin coating material finishing layer having an expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

12. The decorative structure of claim 1 wherein said substrate is configured to have density in the range of about 27 lbs/cu ft to about 30 lbs/cu ft.

13. The decorative structure of claim 1 wherein said substrate is configured to have crush strength of greater than 1500 psi.

14. The decorative structure of claim 1 wherein said substrate is configured to have flex strength of greater than 250 psi.

15. The decorative structure of claim 1 wherein said substrate is configured to have coefficient of thermal expansion in the range of about 6 ppm/inch/degreeF. to about 7 ppm/inch/degreeF.

16. The decorative structure of claim 1 wherein said substrate is configured to have a Thermal K of greater than 0.1 Watt/meter/K.

17. The decorative structure of claim 1 wherein said substrate is configured to have a the Glass Transition Temperature, Tg, of greater than 200 degree F.

18. The decorative structure of claim 6 wherein said substrate comprises about 80% by weight to about 90% by weight of fly ash ceramic balloons and about 10% by weight to about 20% by weight of amine cured epoxy resin.

19. A decorative panel comprising
a substrate having a first surface and a second surface formed of fly ash in the form of ceramic micro balloons having a size in the range of about 50 microns to about 500 microns thinly coated with an amine cured epoxy resin in a ratio that is configured to optimize strength and coefficient of thermal expansion; and
a coating layer applied by capillary action to one of said first surface and said second surface of the substrate wherein said coating layer has at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

20. The decorative panel of claim 19 wherein the ceramic micro balloons size range from about 50 microns to about 300 microns.

21. The decorative panel of claim 20 wherein the ceramic micro have size of about 200 microns.

22. The decorative panel of claim 20 wherein the coating layer comprises a coating material and a coating treatment material which in combination have a coefficient of thermal expansion substantially equal to that of the substrate.

23. The decorative panel of claim 19 wherein said substrate is formed into a selected shape.

24. The decorative panel of claim 19 wherein said substrate comprises about 80% by weight to about 90% by weight of fly ash micro balloons and about 10% by weight to about 20% by weight of amine cured epoxy resin.

25. The decorative panel of claim 24 wherein said amine cured epoxy resin comprises an amine cured Bisphenol-A based epoxy resin.

26. The decorative panel of claim 24 wherein the ratio of ceramic micro balloons to an amine cured epoxy is configured to optimize at least one of a coefficient of thermal expansion in the range of about 6 PPM/inch/degree F. and 7 PPM/inch/degree, a density of about 27 lbs/cu ft to about 30 lbs/cu ft; a crush strength of >1500 psi; a flex strength of >250 psi and a Thermal K of about 0.1 Watt/meter/K and glass transition temperature Tg >200 F.

27. The decorative panel of claim 19 wherein said coating layer has a pair of opposed surfaces and one of the pair of opposed surfaces is bonded to one of said first surface and said second surface of the substrate and the other of said of the pair of opposed surfaces defines an exterior outer surface having a fabricated ornamental appearance.

28. The decorative panel of claim 27 wherein said exterior outer surface is a simulated panel coating.

29. The decorative panel of claim 27 wherein said exterior outer surface is a faux finish.

30. The decorative panel of claim 27 wherein said exterior outer comprises a faux finish having a milled aggregate in a water based acrylic emulsion.

31. The decorative panel of claim 27 wherein said exterior outer comprises a faux finish fabricated from an Aronite brand coating material.

32. A chafing dish serving station comprising
a chafing dish supporting structure having a selected longitudinal dimension and a selected lateral dimension configured for forming a chafing dish receiving section for supporting a chafing dish above a burner placed below the chafing dish, said chafing dish support structure having a selected vertical height and a selected lineal outer length which entirely circumscribes said selected longitudinal dimension and said lateral dimension; and
a decorative shell structure having outer walls having a vertical height substantially equal to said selected vertical height and a lineal dimension substantially equal to elected lineal outer length so as to enclose said chafing dish structure and burner, said decorative shell structure comprising
a substrate formed of fly ash in the form of ceramic micro balloons having a in the range of about 50 microns to about 500 microns thinly coated with an amine cured epoxy resin in a ratio that is configured to optimize strength and coefficient of thermal expansion; and
a coating layer applied to said at least one outer surface having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

33. The chafing dish serving station of claim 32 wherein said substrate has a first surface and a second surface formed of fly ash in the form of ceramic micro balloons having a size of about 200 micron thinly coated with an amine cured epoxy resin in a ratio that is configured to optimize strength and coefficient of thermal expansion, said coating having an exterior outer surface having a fabricated ornamental appearance.

34. A decorative shell for enclosing object comprising a substrate formed of fly ash in the form of ceramic balloons having a size of in the range of about 50 microns to about 500 microns thinly coated with in a bonding agent in a ratio that is configured to optimize strength and coefficient of thermal expansion and form an open cell structure of ceramic micro balloons on at least one outer surface of the substrate; and
a coating layer applied by capillary action to said at least one outer surface having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

35. The decorative shell for enclosing object of claim 34 wherein said substrate has a vertical height substantially equal to a selected vertical height of an object to be enclosed thereby and a lineal dimension substantially equal to a selected lineal dimension of an object to be enclosed thereby so as to enclose said object with said decorative shell.

36. The decorative shell for enclosing structure an object of claim 34 wherein said coating layer defines an exterior outer surface having a fabricated ornamental wherein said enclosed object has an appearance defined by said ornamental appearance.

37. An underlay for use as a component in a decorative structure, said underlay comprising
a substrate formed of fly ash in the form of ceramic balloons having a size of in the range of about 50 microns to about 500 microns thinly coated with a bonding agent in a ratio that is configured to optimize strength and coefficient of thermal expansion and to form an open cell structure of ceramic micro balloons on at least one outer surface of the substrate.

38. The underlay of claim 37 wherein said substrate has at least one outer surface further and further comprises
a coating layer adhereing by capillary action to said at least one outer surface having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

39. The underlay of claim 37 herein said coating layer has an exterior outer surface having a fabricated ornamental appearance.

40. The underlay of claim 39 herein said coating layer having an exterior outer surface having a fabricated ornamental appearance is fabricated as a protective, outer layer providing protection from environmental conditions.

41. The underlay of claim 37 wherein said substrate comprises about 80% by weight to about 90% by weight of fly ash ceramic micro balloons and about 10% by weight to about 20% by weight of an amine cured epoxy resin.

42. A method of forming a decorative comprising the steps of:
fabricating a substrate of fly ash in the form of ceramic micro balloons having a size in the range of about 50 microns to about 500 microns thinly coated with a bonding agent in a ratio that is configured to optimize strength and coefficient of thermal expansion and wherein said substrate has at least one outer surface having an open cell structure formed by the ceramic micro balloons in the bonding agent; and
applying to said open cell structure in the at least one outer surface of the substrate by capillary action a coating layer having at least one of a coefficient of thermal expansion substantially equal to that of the substrate and a expansion characteristic configured to substantially absorb any difference in the coefficient of thermal expansions between the coating layer and substrate to substantially eliminate any physical deformation between the substrate and coating layer forming an exterior outer surface having a fabricated ornamental appearance.

43. The method of claim 42 wherein the step of fabricating a substrate includes a substrate comprising about 80% by weight to about 90% by weight of fly ash ceramic micro balloons and about 10% by weight to about 20% by weight an amine cured epoxy resin.

44. The method of claim 42 wherein the step of fabricating a substrate includes making the substrate fire resistant.

45. The method of claim 42 wherein the step of applying to said outer surface includes using a coating layer having a coating treatment material having a milled aggregate in a water based acrylic emulsion.

46. The method of claim 42 wherein the step of applying to said outer surface includes using a coating layer that is a simulated panel coating.
